(19) United States
(12) Patent Application Publication
(10) Pub. No.: US 2025/0213921 A1
(43) Pub. Date: Jul. 3, 2025

(54) SYSTEMS AND METHODS FOR A VIRTUAL GOLF CADDY ON A MOBILE DEVICE USING LAUNCH MONITOR DATA

(71) Applicant: GOLFTEC ENTERPRISES LLC, Englewood, CO (US)

(72) Inventor: Nick CLEARWATER, Englewood, CO (US)

(21) Appl. No.: 19/003,114

(22) Filed: Dec. 27, 2024

Related U.S. Application Data
(60) Provisional application No. 63/615,949, filed on Dec. 29, 2023.

(51) Int. Cl. A63B 24/00

(52) U.S. Cl. CPC A63B 24/0021; A63B 24/0062; A63B 2024/0028

(57) ABSTRACT

A system for providing a virtual caddy includes a caddy module, the caddy module configured to and executing code to receive a current ball location and a desired ball ending location. The caddy module further configured to access a database of swings with a plurality of clubs and resultant ball trajectories captured by a launch monitor. The caddy module further configured to analyze the database of swings and ball trajectories to determine a suggested club.

### CROSS-REFERENCE TO RELATED APPLICATIONS

This application claims the benefit of U.S. Provisional Application No. 63/615,949 filed Dec. 29, 2023, which is hereby incorporated by reference in its entirety.

### BACKGROUND

Launch monitors are used to track the launch of objects in a variety of sports, including but not limited to golf. Launch monitors rely on a variety of sensors to detect and track the motion of a ball or other sports object, the motion of an implement, such as a club, and the motion of the user or participant. The launch monitor may then predict the path of a ball. Sensors may include optical cameras and radar as well as other sensors.

Users may utilize launch monitors for training and to track their performance. In many scenarios, a user may collect a database of their swings with particular clubs. The launch monitor may analyze the swings and determine the likely trajectory of the golf ball. It would be useful for users to be able to utilize such information to improve their game on the course.

### SUMMARY

In one embodiment, a system for providing a Virtual Caddy includes a caddy module, the caddy module configured to and executing code to receive a current ball location and a desired ball ending location. The caddy module further configured to access a database of swings with a plurality of clubs and resultant ball trajectories captured by a launch monitor. The caddy module further configured to analyze the database of swings and ball trajectories to determine a suggested club. Alternatively, the system further includes a GPS module and the GPS module is configured to and executing code to determine the current ball location based on GPS data. Alternately, the GPS module is configured to and executing code to determine the desired ball ending location based on the GPS data. In one alternative, the GPS module is configured to and executing code to access a golf course database, the golf course database having maps for a plurality of golf courses, retrieve a current course map based on the GPS data, and use the current course map when the determining the current ball location and the desired ball ending location. Alternatively, the caddy module is configured to and executing code to receive a pin location indication from a user and adjust the desired ball ending location based on the pin location. In one alternative, the caddy module determines desired ball path based on the current ball location and the desired ball ending location. Alternatively, the caddy module compares the desired ball path to the swings with a plurality of clubs and resultant ball trajectories and selects a recommended club that is likely to result in the desired ball path. In another alternative, the caddy module uses a least squares analysis to select the recommended club. Alternatively, the caddy module uses the current course map to determine whether there are hazards in the desired ball path and determines a chance of encountering a hazard on the desired ball path. In one alternative, if the chance of encountering a hazard on the desired ball path is high, the caddy module selects an alternative ball path and modifies the recommended club.

In one embodiment, a method of providing a Virtual Caddy includes receiving a current ball location and a desired ball ending location at a caddy module. The method further includes accessing a database of swings with a plurality of clubs and resultant ball trajectories captured by a launch monitor with the caddy module. The method further includes analyzing the database of swings and ball trajectories to determine a suggested club with the caddy module. In one alternative, the method further includes determining the current ball location based on GPS data, with a GPS module. In one alternative, the method further includes determining the desired ball ending location based on the GPS data, with the GPS module. In one alternative, the method further includes accessing a golf course database, the golf course database having maps for a plurality of golf courses, retrieving a current course map based on the GPS data, and using the current course map when the determining the current ball location and the desired ball ending location. In one alternative, the method further includes receiving a pin location indication from a user and adjusting the desired ball ending location based on the pin location. In one alternative, the method further includes determining desired ball path based on the current ball location and the desired ball ending location. Alternatively, the caddy module compares the desired ball path to the swings with a plurality of clubs and resultant ball trajectories and selects a recommended club that is likely to result in the desired ball path. Alternatively, the caddy module uses a least squares analysis to select the recommended club. In another alternative, the caddy module uses the current course map to determine whether there are hazards in the desired ball path and determines a chance of encountering a hazard on the desired ball path. Alternatively, if the chance of encountering a hazard on the desired ball path is high, the caddy module selects an alternative ball path and modifies the recommended club.

### BRIEF DESCRIPTION OF THE FIGURES

FIG. 1 shows a flow chart for one embodiment of a Virtual Caddy;

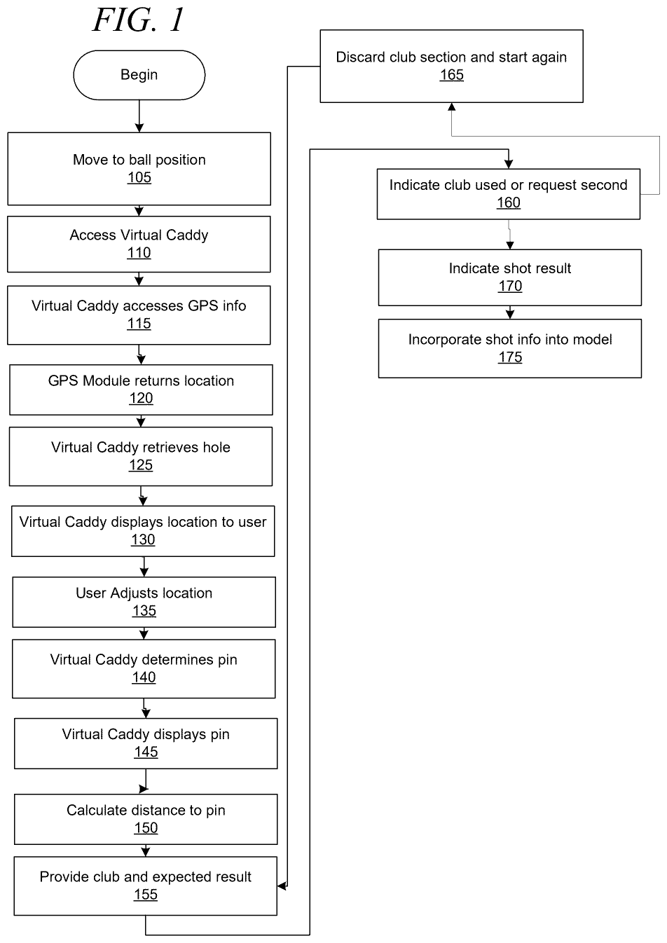

FIG. 2 shows one embodiment of a Virtual Caddy system;

FIG. 3 shows another embodiment for a method of function of a Virtual Caddy system;

FIG. 4 shows another embodiment for a method of function of a Virtual Caddy system.

### DETAILED DESCRIPTION

Certain terminology is used herein for convenience only and is not to be taken as a limitation on the embodiments of the System and Methods for a Virtual Golf Caddy on a Mobile Device Using Launch Monitor Data. In many configurations, a user may collect information concerning his or her golf swing. Typically, this information is collected via a launch monitor. A launch monitor is a golf ball tracking device that may track the user's predicted ball path when hitting a ball as well as the user's body position and path and the user's club path and position. In some alternatives, information can be collected from other sources, such as observation and manual input or other potential sources. Once a database of a user swing and results driving results are gathered with various clubs, a Virtual Caddy may be established. The Virtual Caddy may be deployed in a stand-alone device, a range finder, a smart phone or other device. In many parts of this description, the Virtual Caddy may be described as a Virtual Caddy module, which is not intended to be limiting to a particular deployment of the Virtual Caddy. In operation, the Virtual Caddy will access the database of the user's recorded swings. Based on a user's real-world position on the golf course, the Virtual Caddy will determine what the recommended club is for the user to hit, based on the information in the database. The Virtual Caddy may interact with a GPS module or other system that delivers the position of the user. Based on a map of the golf course the user is on and the GPS position of the user, a desired ball path is determined and they the club may be matched to it. Additionally, the user may augment the information used by the golf caddy either by inputting data or causing the gold caddy to retrieve additional data. This additional data may include the pin position, wind, lie, and other factors.

In one embodiment, a user moves to the position of his ball in step 105. In step 110, user accesses the Virtual Caddy system using a smart phone. As discussed previously, other devices and configurations may be used. In step 115, the Virtual Caddy system accesses a GPS module. This GPS module is located on the smart phone and may use the phone's GPS systems. In step 120, the GPS module returns the location to the Virtual Caddy. In step 125, the Virtual Caddy uses the GPS location to retrieve the golf course the user is on and the hole they are playing. The Virtual Caddy does this by accessing a remote database that stores golf course maps and positioning the expected ball position on the map retrieved. In optional step 130, the Virtual Caddy displays to the user using the smart phone the detected location and hole the user is on. In optional step 135, the user may adjust the hole being played and the precise location on the map displayed on the smart phone. This may be useful especially when the player has made and errant shot and their ball is close to another hole and therefore detected as being on that hole. Additionally, the location of hazards may be taken into account, such as sand traps, water hazards and trees. The Virtual Caddy system may run through vector probabilities (magnitude and direction) for various clubs and plot predicted resulting shots on a virtual map. The club or those clubs with highest probability of being close to the desired shot location will be recommended. This can be done a coordinate basis and relayed to the user to show position on a map.

In step 140 the Virtual Caddy determines the location of the pin on the hole being played. In optional step 145, the pin location may be displayed to the user and thereafter confirmed by the user. The user may also adjust the location of the pin in this step. Alternatively, the Virtual Caddy may have received information from a previous golfer about the pin location (typically pin location is the same at least for an entire day if not longer), or the course management may communicate the pin position.

In step 150, the Virtual Caddy calculates the distance to the pin. In step the Virtual Caddy accesses a database of prior shots made by the user/golfer with a variety of clubs and calculates a club selection for the user which is likely to result in the user's shot reaching the pin. A variety of factors may be taken into account here, including the consistency of the user's swings with particular clubs, the distance, the likelihood of slicing or hooking and other factors relating particularly to the user's swing data. As indicated previously, this swing data is typically collected via multiple launch monitor training sessions. In some alternatives, data may be manually entered, but launch monitor data is likely to contain a much more data rich set of information.

In step 155, the Virtual Caddy provides to the user the suggested club and the expected result. In step 160 the user may indicate that the selected club was used or may request a second club selection. If a second club selection is requested the process repeats, discarding the first result in step 165. In optional step 170, the user may indicate the resulting shot, by either manually entering information or indicating on the smart phone when the ball's position after hitting is reached. In step 175, the Virtual Caddy may incorporate this information to creating better club recommendations.

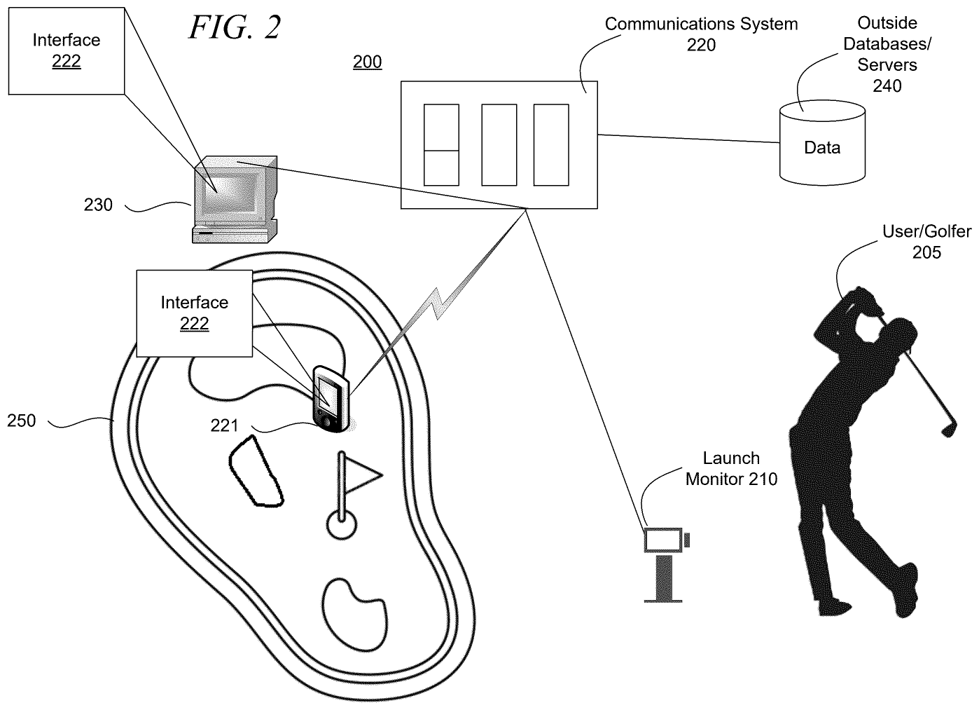

FIG. 2 shows one embodiment of a Virtual Caddy system 200. User/golf 205 prior to using the Virtual Caddy on the course, tracks multiple swings and results with multiple clubs with launch monitor 210. The results may be communicated via communications system 220 to a computer 230 having an interface 222 and an outside database 240. Interface 222 may be a web interface or an application interface or other interface. The user 205 may access, view, and curate the results of their training results. The point of these training results is to generate club vector probabilities for each club the golfer is likely to use on the course. The Virtual Caddy system 200 will make the best recommendation based on the data available, and in some scenarios may ignore certain clubs if no data is available or interpolate likely probabilities based on other existing club data. Database 240 stores available club vector probabilities. When on the course 250, user 205 accesses the Virtual Caddy system 200 via a smartphone 221 having interface 222. Smartphone 221 maybe replace with a range finder having computing and GPS systems or another mobile device. Interface 222 may be a web interface or an application interface or other interface specific to the smartphone 221 or other mobile system. Smart phone 221 via the Virtual Caddy system will then determine a location based on GPS or other inputs, determine the distance to the pin or other shot location goal, and access the database 240 to determine what club has the highest probability of resulting in the desired result by examining the probability vectors of each club generated during the train session or sessions.

In another embodiment, a Virtual Caddy system 300 may function similar to method described in Fi, but instead of providing a club selection, Virtual Caddy system 300 provides a suggested target and club selection. In such a scenario, similar steps are performed.

In some alternatives, the Virtual Caddy the Virtual Caddy may take into account whether conditions, either manually entered by the user or retrieved via online weather resources. The Virtual Caddy may additionally use the database of user swings to indicate whether the user/golfer should swing fully or some degree less that full. Typical indications will be to swing full, three-quarters, half, or one quarter, but other factions or percentages are possible, depending on designer and/or user preference.

In one embodiment, based on previous launch monitor tracking of a user's swing, a user club/swing database is created. Typically, this database will have a user's swing results with various clubs and the launch monitor recorded distance and direction of each shot. This may be stored in the form of a vector with probabilities attached to the magnitude and the direction. For instance, many user's swings will have a normal distribution in terms of distance and direction or a bimodal normal distribution or even a multimodal distribution. For example, a bimodal distribution may be reflective of a user mishitting the ball approximately a quarter of a time and making good contact the remainder of the time. This will result in two different groupings of shot magnitudes and directions. As previously indicated, these results are stored on a per club basis. In operation, the Virtual Caddy can make numerous statistical inquiries to the database and return the club selection that will most likely result in the desired vector.

Additionally, in operation, the Virtual Caddy may collect real course data, based on the results of recommendations to refine the expected results for piratical clubs for particular users. For instance, the user may indicate after a shot is made using a Virtual Caddy recommendation, what the result was of the shot. This may merely be by indicating using a button on the Virtual Caddy that the user has travelled to the new ball position. Using accelerators and GPS tracking, the Virtual Caddy then determines the new position and records the vector that resulted from the particular club used. This is added into the user club/swing database. In some configurations, this is added as if it was merely a swing tracked by the launch monitor. In other configurations, such data may be handled differently and give more weight, as it is real world course data.

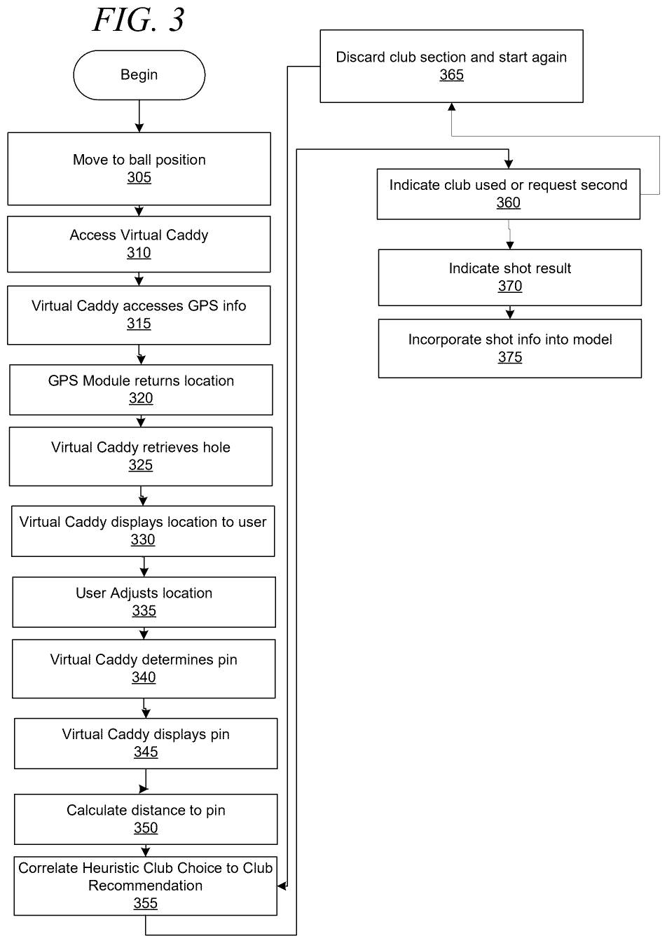

FIG. 3 shows another embodiment of a method of operating a Virtual Caddy system. In this embodiment, the system is a hybrid system, relying on user swing history as well as a database of heuristics, developed by experts concerning likely course play results. For instance, experts may develop heuristics based on experience with the course as to what club should be utilized. In some configurations, this is based on expected distance of a user shot with a particular club, correlated with the expert/pro's heuristic of the desired resulting distance from a shot. In other words, the expert/pro may develop a rule/heuristic in particular scenarios for what the desired shot distance is and then correlate that to a user database of shots, providing for an expected distance of a shot by the user. In step 305, the user moves with the Virtual Caddy system of the position of the ball or near thereto. This is performed so that the GPS or other location based systems of the Virtual Caddy can obtain the correct position of the ball. In step 310 the users accesses the Virtual Caddy system. In step 315, the Virtual Caddy accesses the GPS information of the location or other location based information. This may be done by triangulating on WIFI or cellular signals, or based on dead reckoning from acceleration and movement data, or a combination of the one or more of these techniques. In step 320, the GPS module returns the location. As before, in alternatives, this may be based on other location information. In one alternative, the Virtual Caddy may accesses image data retrieved via a request for the user to image the hole target. In this use case, the Virtual Caddy captures one or more images of the hole target and using image processing techniques, cross references these images with previous images of a database of holes to determine the position of the user/ball. In other words, the Virtual Caddy matches real time or recent images captured by the system and uses likelihood analysis to determine the likely hole that a user is playing and the location on that hole. In step 325, the Virtual Caddy may retrieve the hole that the system has determined the user is playing. In some configurations, enhanced information is provide to the user about the hole concerning recent data for users playing the hole, such as wind conditions, turf conditions, and green conditions or other environmental conditions. One example is wet turf. If the turf is wet, the shot distance is likely to decrease, since the ball will stick and not roll as far. Therefore, the Virtual Caddy may decrease the expected shot distance. In contrast, firm fairways will increase the ball roll and the Virtual Caddy may adjust accordingly. Cold temperatures, may decrease the ball flight distance, and the Virtual Caddy may account for this. In step 320, the Virtual Caddy system may display the location of the ball to the user. In step 325, the user may adjust this location. This may be performed by providing a visual representation of the location of the ball on the course from an overhead shot and the user may using touch based or other interfaces, adjust the location. In some alternatives, an adjusted distance to the pin may be provided to the user and the Virtual Caddy system or an external range finder may scope and adjust this distance. In step 340, the Virtual Caddy determines the pin position. In some configurations, this is based on input from the course managers providing information to the Virtual Caddy to provide pin position. This may alternatively be “crowd sourced” by users playing the hole that day providing pin position. Alternatively, the user may adjust the pin position using an interface. In yet another alternative, the Virtual Caddy may capture one or more images of the green via the user pointing cameras/range finders associated with the Virtual Caddy at the green. These cameras may be physically part of the Virtual Caddy hardware or may exist in another device (smartphone, tablet, rangefinder, etc.) that communicates with the Virtual Caddy. In step 345, the Virtual Caddy displays the pin position. In step 350, the distance to the pin is calculated. (note that throughout the Virtual Caddy may have many different hardware configurations, which include, but are not limited to: a user smartphone, a user tablet, or other user multipurpose device, a module including processing systems and GPS and/or imaging systems (rangefinder) or other sensors that communicates with a user device (smartphone, tablet, etc.), a module including location sensors, communications system, and display and interface systems (touchscreen, etc.) that may or may not communicate with a user device. In other words, the physical architecture of the Virtual Caddy is not intended to be limited to a specific physical structure, unless specifically claimed as such. The Virtual Caddy in many scenarios may communicate with remote databases and computing systems, as previously indicated as well.) In step 355, the Virtual Caddy system determines an appropriate club choice for the user. This is based on expert/pro heuristics that guide the club selection. In many configurations, a database or portion of a database storing heuristics for particular holes is accessed. In many configurations, this database includes data from pros/experts playing the course, their club selection, and the resulting shots. In many configurations, this database includes recommendations for particular clubs for users from particular locations on the course and the expected shot distances from those combinations. In many configurations, this database may include addition instructions on the quality or qualitative swing characteristics, such as swing through, or swing a lesser percentage, or open the club face or shift weight forward or backward. When providing the user a club selection, the user receives the club selection according to the heuristics of the pro/expert, what the expected distance is for the shot, what that corresponds to for the user, instructions on qualitative characteristics of the swing, and any other informational advice in the database for the particular hole according to the stored heuristics. As in previous scenarios, the user in step 360 may indicate that the club is used, request another club, or indicate another club that was used. If another club is requested, then the system recalculates. If not, the shot result is indicated in step 370. This is typically done more or less automatically, when the user goes to the next location to make another shot. The Virtual Caddy may simply indicate that the user should confirm ball position in a prompt, or may assume ball position when the user accesses the Virtual Caddy again to request advice. In step 375 the information gleaned may be incorporated into various models. If pin position was determined, the system may store that information an provide it to others. How the ball played in terms of distance through the air or roll may be stored as well to determine course characteristics. Of course, information concerning the user's particular swing results may be incorporated into the model for a particular user. In general, two types of information may be harvested from each interaction. First, user specific swing results with a particular club may be stored privately for that user. Second, public information may be stored for other Virtual Caddy users to access. This may include pin position or other course information. In scenarios, where the Virtual Caddy includes a camera that continually monitors the swing results and course, the Virtual Caddy may capture the roll of the ball and use that to determine course firmness/roll or course wetness and stickiness.

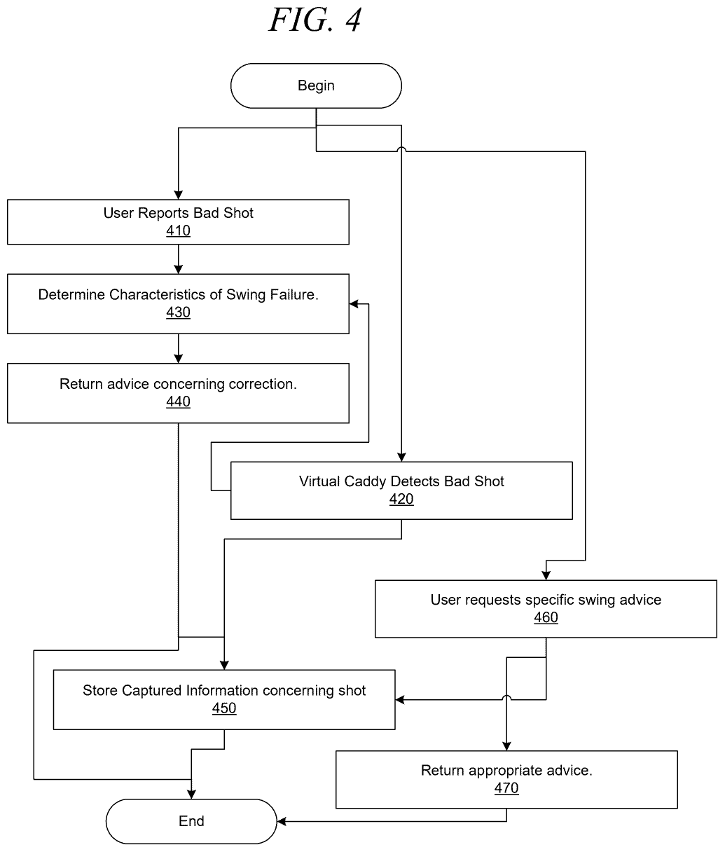

FIG. 4 provides another mode of operation of the Virtual Caddy. In this scenario, there are three main flows of operation. In step 410, the user may report a bad shot.

This may be done in a variety of fashions. The user may through an interface manually report a mishit ball and may indicate further characteristics through a menu, such as “topped the ball” or “swing too deep,” or “big divot”. Alternatively, the user may report a “slice” or “hook” or “loft too high”. Based on this, the system may use a number of heuristics to determine what the likely swing error is. This may be based on a database of heuristics established by pros/experts cross-referencing reported issues to swing corrections. In step 430, the system then determines the characteristics of the swing failure based on cross referencing the database and/or using AI techniques for model building and advice determination. The Virtual Caddy in step 440 returns correction advice. This may be in the form an auditory or textual instruction, e.g. “keep you head down,” or “bend your knees”. This advice, in many scenarios, may be cross referenced with the specific user's swing issues as well. For instance, if in stored swings the user is topping the ball from a failure to keep the user's head stationary, then topping the ball is more likely to result in advice related to this issue. Additionally, an on-the-fly training video maybe provided that the use may access immediately, at a convenient point in the round, or at a later time. In step 450, information concerning the mid hit shot and advice provided is stored. This may be accessed by a training professional or the user at later time to improve training. It may also be incorporated into the model of swings for the user. In an alternative scenario, the Virtual Caddy itself may detect a bad swing based on the result of shot or video/photo footage of a shot (Depending on the configuration of the Virtual Caddy). A similar process is followed of determining the likely characteristics of swing failure in step 440, the return of advice, textual, audio, or video, in step 440 and the storage of captured information in step 450. Swing failure in some scenarios may be determined purely by the position of the ball. For instance, for a right-handed golfer, if shots are consistently far right, a slice is likely. Note that in many scenarios, the Virtual Caddy may be set to automatically give advice, give advice if requested, or not give advice. Even in scenarios where it is configured not to give advice, information concerning a bad shot may be stored in step 450 for usage after the round. Additionally, the user in step 460 may initiate swing advice without issues being detected. This is typically done via menu or other selection system (speech to text may provide for verbal requests of course). Again in step 470 appropriate advice is provided similar to step 440 and information concerning the issue is captured in step 450.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

In various instances, parts of the method may be implemented in modules, subroutines, or other computing structures. In many embodiments, the method and software embodying the method may be recorded on a fixed tangible medium.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

1. A system for providing a virtual caddy, the system comprising:
a caddy module, the caddy module configured to and executing code to:
receive a current ball location and a desired ball ending location;
access a database of swings with a plurality of clubs and resultant ball trajectories captured by a launch monitor;
analyze the database of swings and ball trajectories to determine a suggested club.

2. The system of claim 1, further comprising, a GPS module, the GPS module configured to and executing code to:
determine the current ball location based on GPS data.

3. The system of claim 2, wherein the GPS module configured to and executing code to:
determine the desired ball ending location based on the GPS data.

4. The system of claim 3, wherein the GPS module configured to and executing code to:
access a golf course database, the golf course database having maps for a plurality of golf courses;
retrieve a current course map based on the GPS data;
use the current course map when the determining the current ball location and the desired ball ending location.

5. The system of claim 4, wherein the caddy module is configured to and executing code to:
receive a pin location indication from a user;
adjust the desired ball ending location based on the pin location.

6. The system of claim 5, wherein the caddy module determines desired ball path based on the current ball location and the desired ball ending location.

7. The system of claim 6, wherein the caddy module compares the desired ball path to the swings with a plurality of clubs and resultant ball trajectories and selects a recommended club that is likely to result in the desired ball path.

8. The system of claim 7, wherein the caddy module uses a least squares analysis to select the recommended club.

9. The system of claim 8, wherein the caddy module uses the current course map to determine whether there are hazards in the desired ball path and determines a chance of encountering a hazard on the desired ball path.

10. The system of claim 9, wherein if the chance of encountering a hazard on the desired ball path is high, the caddy module selects an alternative ball path and modifies the recommended club.

11. A method of providing a virtual caddy, the method comprising:
receiving a current ball location and a desired ball ending location at a caddy module;
accessing a database of swings with a plurality of clubs and resultant ball trajectories captured by a launch monitor with the caddy module;
analyzing the database of swings and ball trajectories to determine a suggested club with the caddy module.

12. The method of claim 11, further comprising:
determining the current ball location based on GPS data, with a GPS module.

13. The method of claim 12, further comprising:
determining the desired ball ending location based on the GPS data, with the GPS module.

14. The method of claim 13, further comprising:
accessing a golf course database, the golf course database having maps for a plurality of golf courses;
retrieving a current course map based on the GPS data;
using the current course map when the determining the current ball location and the desired ball ending location.

15. The method of claim 14, further comprising:
receiving a pin location indication from a user;
adjusting the desired ball ending location based on the pin location.

16. The method of claim 5, further comprising:
determining desired ball path based on the current ball location and the desired ball ending location.

17. The method of claim 16, wherein the caddy module compares the desired ball path to the swings with a plurality of clubs and resultant ball trajectories and selects a recommended club that is likely to result in the desired ball path.

18. The method of claim 17, wherein the caddy module uses a least squares analysis to select the recommended club.

19. The method of claim 18, wherein the caddy module uses the current course map to determine whether there are hazards in the desired ball path and determines a chance of encountering a hazard on the desired ball path.

20. The method of claim 19, wherein if the chance of encountering a hazard on the desired ball path is high, the caddy module selects an alternative ball path and modifies the recommended club.
